(19) United States
(12) Patent Application Publication
(10) Pub. No.: US 2013/0024250 A1
(43) Pub. Date: Jan. 24, 2013

(54) SYSTEMS AND METHODS FOR GROUP BUYING AND SOCIAL NETWORK

(71) Applicants: Bo Wu, Santa Clara, CA (US); Yuhong Xiong, Mountain View, CA (US)

(72) Inventors: Bo Wu, Santa Clara, CA (US); Yuhong Xiong, Mountain View, CA (US)

(73) Assignee: LaShou Group Inc.

(21) Appl. No.: 13/185,972

(22) Filed: Jul. 19, 2011

(51) Int. Cl. G06Q 30/00

(52) U.S. Cl. 705/14.1; 705/14.4

(57) ABSTRACT

Computer-implemented methods, systems facilitating the methods, and computer-readable medium storing computer readable code, which, when executed, performs the methods are provided for group-buying and social network services. The methods may include steps of (1) receiving a request from a host to initiate an event that requires a consumption of an item offered by a provider, (2) performing at least one of (a) sending invitations of the event to at least one guest selected by the host, and (b) causing display of an advertisement of the event to be viewed by general public or a particular group, (3) receiving acceptance of participating the event from at least one participant, and (4) informing the host and the at least one participant whether sales of the item is executed or rescinded.

### FIELD OF THE INVENTION

The present invention relates generally to the offer and sale of goods and services, and more specifically to systems and methods for a host to initiate an event that requires a consumption of particular goods or services offered by provider(s), and invite guest(s) on a network, where the sale of the goods and services may be contingent upon one or more of the guest(s) indicating an acceptance of the invitation.

### BACKGROUND

In retailing, a provider typically offers for sale goods and/or services and advertises the same. The advertising and marketing associated with goods and services can be expensive when done through radio or television medium, and extremely ineffective when done through print advertisements. Regardless of the advertising medium however, there is very little reason for the consumer to pass along the advertisement to others, so that a provider must advertise or market the goods and/or service to each individual.

There is currently no system and methods to mutually satisfy the consumer with a capability to invite others to an event that requires a consumption of goods or services while contingent the purchase of the goods and services to a confirmation of the event, and at the same time providing the provider with expense-free advertising and marketing for the goods or services.

### SUMMARY OF THE INVENTION

One embodiment of the present invention provides a computer-implemented method comprising (1) receiving a request from a host to initiate an event that requires a consumption of an item offered by a provider, (2) performing at least one of (a) sending invitations of the event to at least one guest selected by the host, and (b) causing display of an advertisement of the event to be viewed by general public or a particular group, (3) receiving acceptance of participating the event from at least one participant, and (4) informing the host and the at least one participant whether sales of the item is executed or rescinded.

Another embodiment of the present invention provides a system comprising (1) an event initiating module configured to receive a request from a host to initiate an event that requires a consumption of an item offered by a provider, (2) an invitation sending module configured to perform at least one of (a) sending invitations of the event to at least one guest selected by the host, and (b) causing display of an advertisement of the event to be viewed by general public or a particular group, (3) an acceptance receiving module configured to receive acceptance of participating the event from at least one participant, and (4) a deal informing module configured to inform the host and the at least one participant whether sales of the item is executed or rescinded.

Another embodiment of the present invention provides a computer-readable medium storing computer readable code, which, when executed, performs a method comprising (1) receiving a request from a host to initiate an event that requires a consumption of an item offered by a provider, (2) performing at least one of (a) sending invitations of the event to at least one guest selected by the host, and (b) causing display of an advertisement of the event to be viewed by general public or a particular group, (3) receiving acceptance of participating the event from at least one participant, and (4) informing the host and the at least one participant whether sales of the item is executed or rescinded.

These and other embodiments and advantages thereof will become more readily apparent from the attached drawings and the detailed description that follow.

### BRIEF DESCRIPTION OF THE DRAWINGS

The preferred embodiments of the invention will be described in conjunction with the appended drawings provided to illustrate and not to limit the invention, where like designations denote like elements, and in which:

FIG. 1 illustrates an exemplary computer system according to one embodiment of the present invention.

FIG. 2A illustrates a flow chart according to a first non-limiting example of the present invention.

FIG. 2B illustrates a flow chart according to a second non-limiting example of the present invention.

FIG. 2C illustrates a flow chart according to a third non-limiting example of the present invention.

### DETAILED DESCRIPTION OF THE PREFERRED EMBODIMENTS

One embodiment of the present invention provides a computer-implemented method, which comprises (1) receiving a request from a host to initiate an event that requires a consumption of an item offered by a provider, (2) perfoiining at least one of (a) sending invitations of the event to at least one guest selected by the host, and (b) causing display of an advertisement of the event to be viewed by general public or a particular group, (3) receiving acceptance of participating the event from at least one participant, and (4) informing the host and the at least one participant whether sales of the item is executed or rescinded.

The host may be any individuals or entities (e.g., companies, organizations, government, etc.). The provider may be any individuals or entities who offer for sale of the item, for example an individual seller, a merchant, a manufacture, or a vender, etc. The provider may be local, national or global. In some embodiments, the host may also be the provider of the item. In some other embodiments, the host may be a consumer of the item. The host may also simply be an organizer of the event who may not participate the event himself, and consequently is not required to purchase the item as the participants do.

In some embodiments, the system may cause display of a profile of a plurality of users, based on which the host may decide who to invite. Each user of the system may define his/her own micro-communities of contacts. For example, each user typically has the ability to define the parameters, such as who he/she wants to interact with, who he/she shares information with, who has access to his/her personal data and who to request a connection. In some embodiments, users who are connected to each other as friends are provided access to private profiles of each other. In some other embodiments, such permission of reviewing private profiles may only be granted to one side of the connection. For example, user A may have a plurality of followers including users B, C, D, E, where B-E can view the private profile of A but A does not have the peimission to view the private profiles of B-E. Each individual in a user's group of friends/followers can have his/her own set of friends/followers, some of which may overlap with others, and some of which do not.

In some embodiments, the host may choose to send invitations to or allow such invitations to be viewed by one or more of his/her micro-communities of friends/followers. In some other embodiments, the host may send invitations to or allow the invitations to be viewed by only particularly selected individuals. The host may choose to send invitations to one or more selected individuals already connected to him/her. In some other embodiments, the host may send invitations to one or more selected individuals that are not yet connected to him/her. In these embodiments, the host may set the acceptance of the invitation of the even contingent to an acceptance of an invitation of been connected on the social network.

Of course, the host may choose to use any combinations of the above-described methods to send invitations or allow the invitation to be viewed by the invited guests. The host may, alternatively or in addition, allow the invitation of the event to be viewed by the general public.

The invitation of the event can be sent to the guests via at least one of phone, web, and mobile communication systems, such as but not limited to short message service, email, and social networks. Similarly, the invitation may be accepted by the participants via at least one more of phone, web, and mobile communication systems, such as but not limited to short message service, email, and social networks. The methods of sending invitation and receiving the acceptance of the invitation may be independently chosen.

In some embodiment, the event may be public and involve a big group of participants. In some other embodiments, the event may be private, involving a smaller number of participants. For example, only one guest can be invited for a dating event where the host and the only guest may share a 2-person dinner certificate. In some other embodiments, more than one guests may be invited to share an item such as a bus service or a group coupon, etc. For example, in a group traveling event to a resort, a group resort certificate may be shared among the participants.

In some other embodiments, the event may be contingent to a predeteimined tipping point being attained. The tipping point may be a minimum number of participants and/or a minimum quantity of items being ordered for the event. The tipping point may be set by the provider who advertises the item, and/or by the host who initiates the event. If different tipping points are set by the host and the provider, the event would be confirmed only when both tipping points are attained. In some embodiments, the sales of the item may be contingent only to an indication of acceptance from one participant. For example, if the event is a 2-person event, the sales of item may be executed when the only guest accepts the invitation.

In these embodiments, sales will be executed if the tipping point is attained during the predetermined period of time. Conversely, if the tipping point is not reached in the allotted time, then the offer of the item will be rescinded or rejected, the event will be cancelled, and the host/participants will not be charged.

Upon confirming the event, the sales are executed. The host and the participants will be consequently charged of the asking price of the item. Each participant may be charged using a method of payment that he/she desires (e.g., credit card, debit card, Paypal, RTM, or any other suitable methods). At this time (or shortly thereafter), the provider would receive a payment based on a previous agreement between the provider and the owner of the system for a portion of the sale of the item, after taking out the cost charged by the owner of the system.

In some embodiments, verification messages will be sent to the host and/or participants for redeeming the item after the sales are executed. The verification messages validating the purchase may be provided in any desired forms such as email, coupon, gift certificate, verification code, and the like, which can be presented to the provider by a user device (or be printed out) for redeeming the item purchased. The verification messages sent to the host and the participants may be same or different. In some embodiments, the validation of the purchase of the item requires a combination of the verification messages received by the host and the participants. In some other embodiments, the validation of the group purchase of the item requires only the verification message received by the host. In other words, the item may be redeemed by the host on behalf of the whole group. Alternatively, each of the host and the participants may redeem his/her own portion of the purchased item individually.

When more than one guests are invited, all participants may be asked to pay a same price for the item. In some other embodiments, different guests may be asked to pay a different price for the item. In some embodiments, the system may cause display of a list of participants that have indicated an acceptance. In some embodiments, such a participant list can be viewed only by the host. In some other embodiments, the participant list can be viewed by the general public or by the guests invited. Consequently, the participants who sign up later may have a greater certainty regarding who other participants are, and may then value the event differently. The provider may therefore choose to request a participant who accepts the invitation earlier to pay a lower price than another participant who accepts the invitation at a later time. In a non-limiting example, the first 10 participants may receive a $20 deduction to a regular price of the item, while the next 10 participants receive only a $10 deduction to the regular price of the item, and so on. Of course, any other desirable price module may be used. For example, the price of the item may be set to depend upon the total number of the participants and/or the total number of the quantity of the item being ordered.

Alternatively, the host, rather than the provider, may set the price for the guests. For example, the host may choose to pay all of the total cost such that the participants can join in the event for free. Alternatively, the host may choose to pay a first portion of an asking price of the item and set another price for each of the guests to pay. For example, when the provider asks $80 for a 2-person dinner certificate, the host may choose to pay the $80 in full such that the guest who accepts the invitation would be requested to pay nothing. The host may choose to pay only $70 or less, such as $40 or $30, and ask the guest to pay the rest when accepting the invitation. When more than one guests are invited, the host may ask the guests to pay a same price. Alternatively, the host may ask different guests to pay different prices. Similarly, the above-explained differentiated price models may be used. A coupon or other verification message for redeeming the item will be forwarded to the host and the participants after the cost is paid in full.

Typically, the owner of the system may be responsible for negotiating the deal of discounted retailing with the provider. However, the host may also negotiate with the provider to obtain a deal, and then submit to the system a request for displaying the advertisement of the deal. The system will then cause display of the advertisement after the credibility of the deal negotiated by the host being verified by the owner of the system.

In some embodiments, the host, the participants and/or the provider may, through the system, make an appointment regarding when, where, how and/or other details regarding redeeming the item.

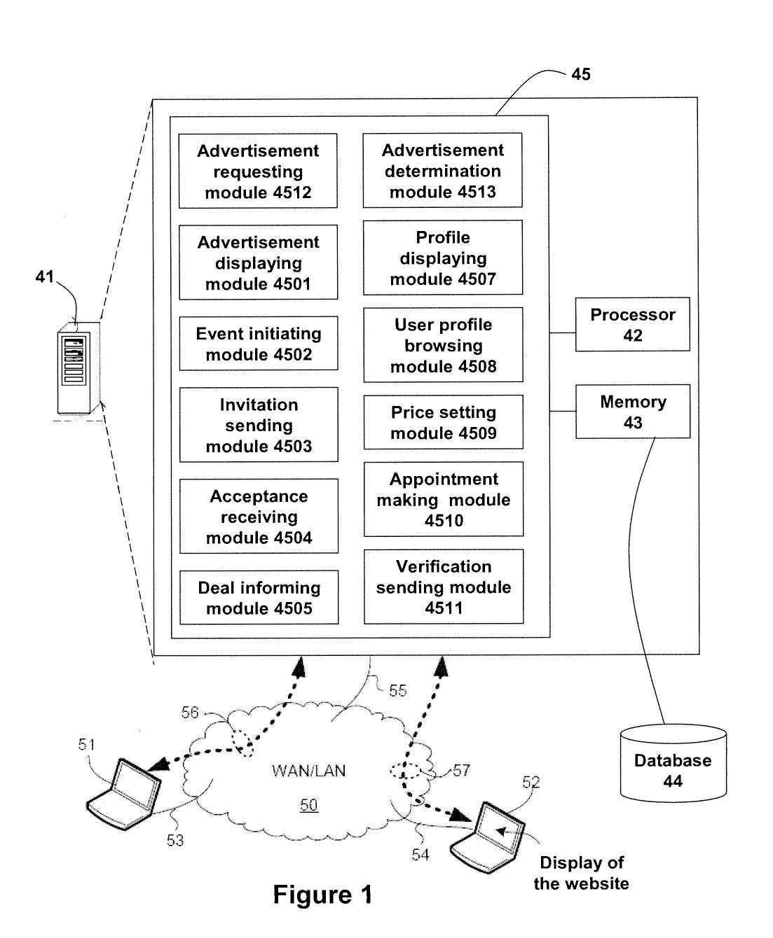

The above described method may be implemented by any suitable systems. As illustrated in FIG. 1, a system according to one embodiment of the present invention may comprise a server 41, a first user device 51, a second user device 52, and a wide-area network (WAN) or local-area network (LAN) 50 that interconnects the server 41 and user devices 51-52 via wired or wireless communication links 53-55. The system may be used to provide social network and group-buying services to the users. Basically, the users may utilize user devices 51-52 to communicate with the server 41 for organizing events, browsing profiles of others, and purchasing featured products. Any desired devices, such as cell phone, PDA, computer and other electronic devices that allow transmission of data to and from the server 41 may be used as the user devices 51-52.

The server 41 comprises a processor 42, a memory 43 that connects to a permanent database 44, and a group-buying and social network management module 45. The group-buying and social network management module 45 comprises an advertisement displaying module 4501, an event initiating module 4502, an invitation sending module 4503, an acceptance receiving module 4504, and a deal informing module 4505. The advertisement displaying module 4501 may be configured to cause display of an advertisement of an item. The event initiating module 4502 may be configured to receive a request from a host to initiate an event that requires a consumption of the item. The invitation sending module 4503 may be configured to perform (a) sending invitations of the event to at least one guest selected by the host, (b) causing display of an advertisement of the event to be viewed by general public or a particular group, or both. The acceptance receiving module 4504 may be configured to receive acceptance of participating the event from at least one participant. The deal informing module 4505 may be configured to inform the host and/or the at least one participant whether sales of the item is executed or rescinded.

In some embodiments, the group-buying and social network management module 45 further comprises a user profile displaying module 4507, a user profile browsing module 4508. The user profile displaying module 4507 may be configured to cause display of a profile of a plurality of users, while the user profile browsing module 4508 may be configured to allow the host to browse the profile of the plurality of users for selecting the at least one guest to invite.

In some embodiments, the group-buying and social network management module 45 further comprises a price setting module 4509. The price setting module 4509 may be configured to allow the host and/or the provider to set a price for the at least one guest to pay. If more than one guests are invited different guests may be asked to pay a same or different price.

In some embodiments, the group-buying and social network management module 45 further comprises an appointment making module 4510. The appointment making module 4510 may be configured to allow the host, the at least one guest, and/or the provider to make an appointment for redeeming the item.

In some embodiments, the group-buying and social network management module 45 further comprises a verification sending module 4511. In some embodiments, the verification sending module 4511 may be configured to send a first verification message to the host and/or to send a second verification message to the at least one guest.

In some embodiments, the group-buying and social network management module 45 further comprises an advertisement request module 4512 and an advertisement determination module 4513. The advertisement request module 4512 may be configured to receive a request from the host to display an advertisement presenting an asking price for an item contingent to a predetermined tipping point being reached during a predetermined period of time. The advertisement determination module 4513 may be configured to determine whether or not to display the advertisement based on a result of verifying the credibility thereof by the system owner.

The different modules within group-buying and social network management module 45 are function modules that interwork with each other. The function modules, when executed by processor 42, allow the system to effectively and efficiently manage the above-described group-buying and social networking activities. If desired, one or more of the function modules may be omitted. Of course, additional modules may be added if needed. Communication messages (e.g., 56 and 57) may be exchanged between the server 41 and user devices 51-52, etc., via the wide-area network (WAN) or local-area network (LAN) 50.

In a non-limiting example, a user may utilize a display screen of his/her user device, to browse product/service information via the advertisement displaying module 4501, and to browse profiles of other users for selecting who to invite as a guest via the user profile displaying module 4507. The user may then initiate an event that requires a consumption of the product/service via the event initiating module 4502. The event invitations (or display of such invitation) can then be viewed by the general public, or selected micro-communities/individuals the host desires to invite via the invitation sending module 4503. The guests may then browse information of the product/service via the advertisement displaying module 4501, and to browse the profiles of the host's and other guests' or participants' via a user profile displaying module 4507 to decide whether or not to accept the invitation. If he/she decide to join in the event, he/she can then communicates to the server his/her acceptance via the acceptance receiving module 4504. The activities performed by the users and the other information related to the event and purchase of the product/service may be saved by server 41 onto database 44, which can then be utilized for statistic analysis or other purposes.

The functions described above may be implemented in hardware, software, firmware, or any combinations thereof. If implemented in software, the functions may be stored on or transmitted over as one or more instructions or code on a computer readable (processor-readable) medium. Computer-readable media include both computer storage media and communication media including any medium that facilitates transfer of a computer program from one place to another. A storage media may be any available media that can be accessed by a computer or similar devices. By way of example, and not limitation, such computer-readable media can comprise RAM, ROM, EEPROM, CDROM or other optical disk storage, magnetic disk storage or other magnetic storage devices, or any other medium that both can be used to carry or store desired program code in the form of instructions or data structures, and can be accessed by a computer or similar devices. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies are included in the definition of medium. Disk and disc, as used herein, include compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media.

### Non-Limiting Illustrative Example I

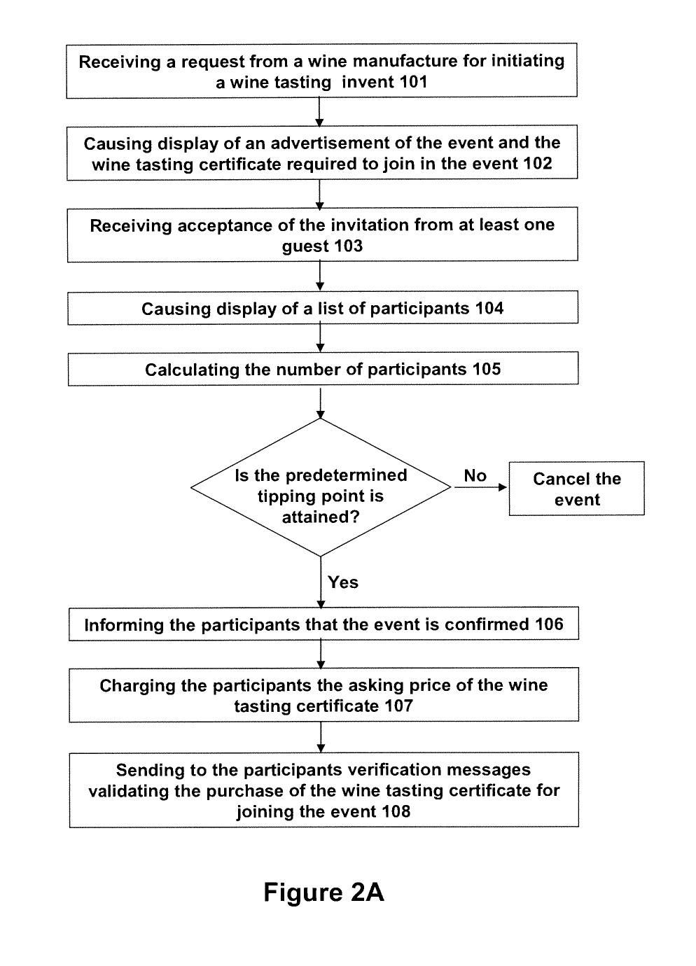

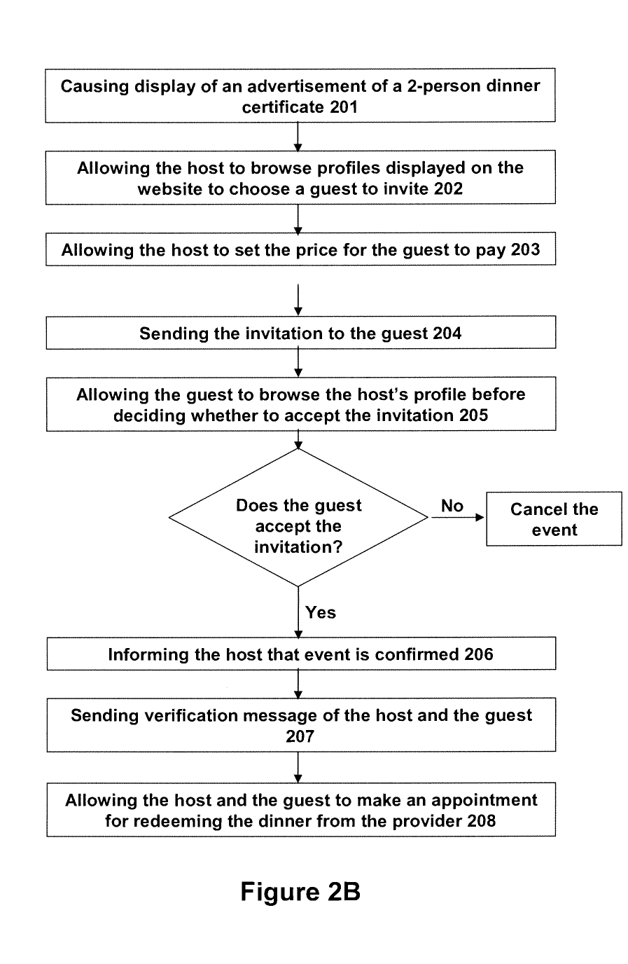

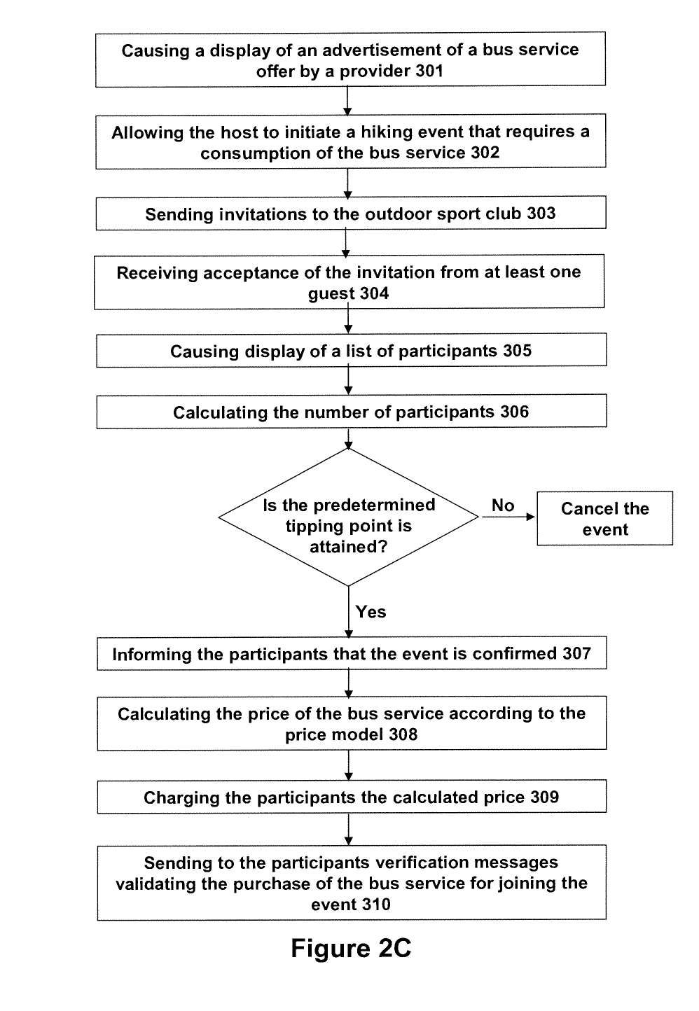

FIG. 2A illustrates a flow chart according to a first non-limiting example of the present invention. An event of wine tasting initiated by a wine manufacture will be used in the following description for purpose of illustration. In this non-limiting example, the wine manufacture would like to host the event of wine tasting on a particular time, such as 6-9 pm on Jul. 4, 2012, at a particular venue. The host (i.e., the wine manufacture), who is also a provider in this non-limiting example, would like to have the event open to the general public. Each of the participants would need to purchase a wine tasting certificate for joining in the event.

First, as shown in FIG. 2A, at step 101, the request from the wine manufacture to initiate the event is received by the server, which then at step 102 causes display of advertisement of such a wine tasting event and the wine tasting certificate required to join in the event. The wine manufacture may contingent the event to the total number of guests indicating acceptance during a predetermined period of time (e.g., 30 days), exceeding a predetermined tipping point (e.g., 85 participants). In this non-limiting example, the host chooses to allow such an advertisement been viewed by the general public. Optionally, the host may, in addition, choose to send direct invitations to some particular groups or individuals of course.

Next, at step 103, the system receives confirmation from guests who indicate an acceptance of the invitation. The system may then, at step 104, causes display a list of participants (i.e., guests who have already indicated an acceptance to the invitation). Other guests may view such a list of participants, before deciding whether he/she shall join in.

Further, at the end of the 30 days period, the number of participants will be calculated at step 105. If 85 or more guests accept the invitation anytime by the end of the 30 days, the event is confirmed, and the host and the participants would be informed, at step 106. The participants may then be charged the asking price of the wine tasting certificate, at step 107. The invitation may be closed, or be set to stay open until a predetermined maximum number of participants is reached. If the number of guests indicating the acceptance of the invitation is less than 85 by the end of the 30 days period (i.e., the tipping point set by the host/provider is not attained), the event would be cancelled, and the participants would not be charged.

Finally, at step 108, verification messages would be send to the participants for redeeming a wine tasting certificate at the venue.

The wine manufacturer may choose to charge all of the participants a same price, for example, 80 dollars per certificate. The wine manufacturer may alternatively choose to charge different participants differently. For example, the first 25 guests that accept the invitation receive a 50% discount (a $80 certificate for a cost of $40). The subsequent participants (number 26 through 50) to accept the invitation receive a 40% discount (a $80 certificate for a cost of $48). The next subsequent participants (number 51 through 85) to accept the invitation receive a 20% discount (a $80 certificate for a cost of $64). The latest participants (number 86 through 100) to accept the invitation receive no discount (a $80 certificate for a cost of $80).

Of course, the wine manufacturer may choose to use other pricing models. For example, the wine manufacture may choose to provide the wine tasting certificate to selected celebrities for free or even provide a payment to the selected celebrities if they accept the invitation, because more guests may decide to join in the event for spending time with these celebrity participants.

The wine manufacturer may choose to allow the guest to further invite one or more guests (e.g., friends/followers) of their own. For example, celebrity guests may be allowed to forward invitations to his/her followers.

Alternatively, the wine manufacture may choose to have the event open only to a particular group of people (e.g., members of a wine-lover association) or to individual guests selected by other methods, rather than to the general public.

### Non-Limiting Illustrative Example II

FIG. 2B illustrates a flow chart according to a second non-limiting example of the present invention. An dating event initiated by user X is used in the following description for purpose of illustration. In this non-limiting example, X hopes to invite a guest to share 2-person dinner certificate costing $100 with him/her.

First, as shown in FIG. 2B, at step 201, an advisement of the 2-person dinner certificate may be viewed on a website that provides group-buying and social network services.

After browsing a plurality of user profiles displayed on the website at step 202, X may choose to invite Y to share the 2-person dinner certificate with him/her and submit a request via the system.

Further, X may set the price for Y to pay at step 203. For example, X may choose to pay the cost of the 2-person dinner in full, so that the dating event would be free for Y to participate. X may alternatively choose to pay only a portion of the $100 cost, and ask Y to pay the rest when accepting the invitation. For example, X may choose to pay $50 (or $70) and set the price for Y to pay as $50 (or $30).

At step 204, such an invitation, including the price information, will be send to Y by one or more methods described above. Y may then browse the profile of X's, before deciding whether or not to accept the invitation, at step 205. If Y decides to accept the invitation, X (or both X and Y) would be informed that the event is confirmed at step 206.

The sale of the 2-person dinner certification will then be executed, followed by sending verification messages to both X and Y for redeeming the 2-person dinner purchased, at step 207. In this non-limiting example, the verification messages sent to X and Y may be different. To redeem the dinner, both X and Y will be requested to show up at the venue, and the combination of the two verification messages may be required to validate the purchase of the 2-person dinner.

X and Y may also make an appointment with each other via the system regarding when to redeem the dinner purchased at step 208.

In the above description, the sale of the 2-person dinner certificate is contingent to receiving an acceptance of the invitation from the guest Y. However, the host X may also choose to purchase the certificate no matter whether the guest accepts the invitation or not. If Y turns down the invitation, X can then invite another guest to share the item. Furthermore, rather than a dating event described above, X may choose to initiate a party or other group activities instead, for which more than one guests may be invited.

### Non-Limiting Illustrative Example III

FIG. 2C illustrates a flow chart according to a third non-limiting example of the present invention. A outdoor event of hiking may be initiated by user P in the following description for purpose of illustration. In this non-limiting example, the hiking event would require a bus service between the city and a desired destination for hiking. P chooses to invite only members of a particular micro-community, such as an outdoor sport club.

First, at step 301, P may browse the website and identify a bus service provider, who have presented an advertisement of its service on the website. In this non-limiting example, the bus service provider may choose to advertise a price depending on the number of participants. For example, if 1-9 people purchase the service each participant will be charged $100 for the service, if 10-19 people purchase the service each participant will be charged $90 for the service, if 20-29 people purchase the service each participant will be charged $80 for the service, if 30-40 people purchase the service each participant will be charged $70 for the service.

Next, at step 302, P may request to initiate the hiking event open only to the outdoor sport club. P may set the event contingent to the total number of guests indicating acceptance during a predetermined period of time, for example 2 weeks, exceeding a predetermined tipping point, for example 10.

The system will then, at step 303, send invitations to the members of the club, who can then view the information regarding the required bus service and other information regarding the event. If guests Q, R and S decide to join in, they may indicate an acceptance of the event via the system, at step 304.

The system may then, at step 305, causes display of a list of participants (i.e., guests who have already indicated an acceptance to the invitation). Other guests may view such a list of participants, before deciding whether he/she shall join in.

Further, at the end of the 2 weeks period, the number of participants will be calculated at step 306. If 10 or more guests accept the invitation any time by the end of the 2 weeks period, the event is confirmed, and the host and the participants would be informed, at step 307. The invitation may be closed, or be set to stay open until a predetermined the maximum number, for example 40, of participants is reached. If the number of guests indicating the acceptance of the invitation is less than 10 by the end of the 2 weeks period (i.e., the tipping point set by the host is not attained), the event would be cancelled, and the host and the participants would not be charged for the bus service.

The price of the service will be calculated at step 308, based on the total number of the participants according to the price model advertised by the bus service provider.

The participants may then, at step 309, be charged of the price calculated at step 308. Finally, at step 310, verification messages would be send to the participants for redeeming the bus service purchased.

The host, participants and the bus service provider may then make an appointment via the system regarding when and where to pick up everybody, etc.

The host P may choose to allow the guest to further invite one or more guests of their own. For example, the guests may be allowed to forward invitations to his/her family members or friends who are not a member of the outdoor sport group.

Alternatively, the host may choose to have the event open to the general public, or individuals selected by other methods, rather than the particular outdoor sport group as described above.

The above-described embodiments and examples are to be considered in all respects only as illustrative and not restrictive, and the scope of the invention is, therefore, indicated by the appended claims rather than by the foregoing description. Those of skill in the art will recognize changes, substitutions and other modifications that will nonetheless come within the scope of the invention and range of the claims.

What is claimed is:

1. A computer-implemented method, comprising:
receiving a request from a host to initiate an event that requires a consumption of an item offered by a provider;
performing at least one of (a) sending invitations of the event to at least one guest selected by the host, and (b) causing display of an advertisement of the event to be viewed by general public or a particular group;
receiving acceptance of participating the event from at least one participant; and
informing the host and the at least one participant whether sales of the item is executed or rescinded.

2. The computer-implemented method of claim 1, further comprising causing display of an advertisement of an item.

3. The computer-implemented method of claim 2, wherein:
the advertisement of the item includes presenting an discounted asking price of the item if a predetermined tipping point is attained during a predetermined period of time, and
whether sales of the item is executed or rescinded is determined by comparing the predetermined tipping point with the a total number of participants that have indicated an acceptance during the predetermined period of time.

4. The computer-implemented method of claim 1, further comprising:
causing display of a profile of a plurality of users; and
allowing the host to browse the profile of the plurality of users for selecting the at least one guest to invite.

5. The computer-implemented method of claim 1, wherein:
the invitation of the event is sent to the at least one guest via at least one of phone, web, and mobile communication systems, and
the invitation of the event is accepted by the at least one participant via at least one of phone, web, and mobile communication systems.

6. The computer-implemented method of claim 1, wherein:
more than one guests are invited, and
different guests may be asked to pay a same or different price.

7. The computer-implemented method of claim 1, further comprising causing display a list of participants that have indicated an acceptance.

8. The computer-implemented method of claim 1, wherein:
more than one guests are invited, and
a participant who indicates an acceptance of the event earlier pays less than another participant who indicates an acceptance of the event later.

9. The computer-implemented method of claim 1, further comprising allowing the host to set a price for the at least one guest to pay, wherein if more than one guests are invited different guests may be asked to pay a same or different price.

10. The computer-implemented method of claim 1, wherein the host is the provider.

11. The computer-implemented method of claim 1, further comprising allowing an appointment for redeeming the item to be made among the host, the at least one guest, and the provider.

12. The computer-implemented method of claim 1, further comprising sending a first verification message to the host and sending a second verification message to the at least one guest.

13. The computer-implemented method of claim 12, wherein:
only one guest is invited,
the event includes sharing the item between the host with the guest, and
the combination of the first and second verification messages is configured to validate the executed sales of the item.

14. A system, comprising:
an event initiating module configured to receive a request from a host to initiate an event that requires a consumption of an item offered by a provider;
an invitation sending module configured to perform at least one of (a) sending invitations of the event to at least one guest selected by the host, and (b) causing display of an advertisement of the event to be viewed by general public or a particular group;
an acceptance receiving module configured to receive acceptance of participating the event from at least one participant; and
a deal informing module configured to inform the host and the at least one participant whether sales of the item is executed or rescinded.

15. The system of claim 14, further comprising an advertisement displaying module configured to cause display of an advertisement of an item;

16. The system of claim 15, wherein:
the advertisement of the item includes presenting an discounted asking price of the item if a predetermined tipping point is attained during a predetermined period of time, and
whether sales of the item is executed or rescinded is determined by comparing the predetermined tipping point with the a total number of participants that have indicated an acceptance during the predetermined period of time.

17. The system of claim 14, further comprising:
a user profile displaying module configured to cause display of a profile of a plurality of users; and
a user profile browsing module configured to allow the host to browse the profile of the plurality of users for selecting the at least one guest to invite.

18. The system of claim 14, wherein:
the invitation of the event is sent to the at least one guest via at least one of phone, web, and mobile communication systems, and
the invitation of the event is accepted by the at least one participant via at least one of phone, web, and mobile communication systems.

19. The system of claim 14, wherein:
more than one guests are invited, and
different guests may be asked to pay a same or different price.

20. The system of claim 14, further comprising a participants list displaying module configured to causing display a list of participants that have indicated an acceptance.

21. The system of claim 14, wherein:
more than one guests are invited, and
a participant who indicates an acceptance of the event earlier pays less than another participant who indicates an acceptance of the event later.

22. The system of claim 14, further comprising a price setting module configured to allow the host to set a price for the at least one guest to pay, wherein if more than one guests are invited different guests may be asked to pay a same or different price.

23. The system of claim 14, wherein the host is the provider.

24. The system of claim 14, further comprising an appointment making module configured to allow an appointment for redeeming the item to be made among the host, the at least one guest, and the provider.

25. The system of claim 14, further comprising a verification sending module configured to send a first verification message to the host and to send a second verification message to the at least one guest.

26. The system of claim 25, wherein:
only one guest is invited,
the event includes sharing the item between the host with the guest, and
the combination of the first and second verification messages is configured to validate the executed sales of the item.

27. A non-transitory computer-readable medium storing computer readable code, which, when executed, performs a method comprising:
receiving a request from a host to initiate an event that requires a consumption of an item offered by a provider;
performing at least one of (a) sending invitations of the event to at least one guest selected by the host, and (b) causing display of an advertisement of the event to be viewed by general public or a particular group;
receiving acceptance of participating the event from at least one participant; and
informing the host and the at least one participant whether sales of the item is executed or rescinded.
